(19) United States
(12) Patent Application Publication
(10) Pub. No.: US 2004/0083191 A1
(43) Pub. Date: Apr. 29, 2004

(54) Intelligent classification system

(76) Inventors: Christopher Ronnewinkel, Heidelberg (DE); Matthias Kaiser, Mountain View, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/330,402

(22) Filed: Dec. 27, 2002

Related U.S. Application Data
(60) Provisional application No. 60/421,650, filed on Oct. 25, 2002.

(51) Int. Cl. G06E 1/00; G06E 3/00; G06G 7/00; G06F 15/18; G06N 5/02; G06F 17/00

(52) U.S. Cl. 706/20

(57) ABSTRACT

A system is disclosed to provide intelligent classification services. The system includes a classifier that provides one or more recommendations based on an incoming message. The system may include a user application that allows an incoming message to be processed by the classifier and may be utilized to respond to incoming messages.

### CROSS-REFERENCE TO RELATED APPLICATION

This application claims priority from U.S. Provisional Application Serial No. 60/421,650, filed on 25 Oct. 2002.

### TECHNICAL FIELD

The disclosure relates to classifying information and providing recommendations based on such classification.

### BACKGROUND

The increased capability of computers to store vast amounts of on-line information has led to an increasing need for efficient data classification systems. Data classification systems are especially needed for natural language texts (e.g. articles, faxes, memos, electronic mail, etc.) where information may be unstructured and unassociated with other texts. The effect of this is that users are forced to sift through the increasing amount of on-line texts to locate relevant information. Users require that classification systems provide useful information under particular circumstances and distinguish useful information from other information.

### SUMMARY

A system is disclosed to provide intelligent classification services. The system includes a classifier that provides one or more recommendations based on an incoming message. The system may include a user application that allows an incoming message to be processed by the classifier and may be utilized to respond to incoming messages.

Various aspects of the system relate to providing recommendations and responding to incoming messages.

For example, according to one aspect, a method includes receiving a message including a request for information, classifying the request for information based upon features of the message, and providing a recommendation based upon the classification of the message.

In some implementations, providing a recommendation may include providing a solution based on a problem description contained in the incoming message. In other implementations, the recommendation may be a list of identifiers, each of which corresponds to a respective group of one or more suggested persons or entities knowledgeable about subject matter in the problem description.

In another aspect, a method includes comparing the request for information with previous requests for information, and determining which previous requests are most similar to the request for information.

In another aspect, a method includes providing a recommendation by generating a classification result using as input a list of previous requests for information, calculating an accuracy measure using class-weights associated with the candidate classes present in the input, and comparing the accuracy measure to a predetermined value.

In some implementations, the method may also include displaying a class-score indicating a text-mining similarity of a class with the request for information, displaying messages from the candidate classes, sending a recommendation based on the accuracy measure and the predetermined value comparison and routing the message to an expert to associate a response.

In another aspect, a method includes associating a class with the message and associating a tag value to a class-equivalent as indicia of relevance to a class-center.

A system, as well as articles that include a machine-readable medium storing machine-readable instructions for implementing the various techniques, are disclosed. Details of various implementations are discussed in greater detail below.

In some implementations, one or more of the following advantages may be present. In a customer interaction center context the system may provide solution recommendations to customers based on an accurate classification of customer problem descriptions, sent via e-mail or any other communications medium, to problems most similar in meaning. This may have the advantage of reducing cost and time associated with searching for customer solutions. The system may provide routing services whereby problem descriptions may be classified and routed to an agent most competent and familiar with the customer problem.

The system may also be used in the context of a sales scenario. For example, if a customer sends a message that contains product criteria relating to a purchase, the system may match such product criteria with product descriptions in a product catalog or with other examples of customer product descriptions to facilitate the sale. The system may also provide cross-sell recommendations for additional purchases. Routing services also may be provided so that the most effective sales agent knowledgeable regarding a particular product is assigned.

Additional features and advantages will be readily apparent from the following detailed description, the accompanying drawings and the claims.

### BRIEF DESCRIPTION OF DRAWINGS

FIG. 1 illustrates a computer-based system for intelligent classification.

FIG. 2 illustrates a maintainer user interface.

FIG. 3 illustrates a display screen to process incoming messages.

FIG. 4 illustrates a solution search display for responding to incoming messages.

FIG. 5 illustrates a flow chart for the classification process implemented by the classifier.

### DETAILED DESCRIPTION

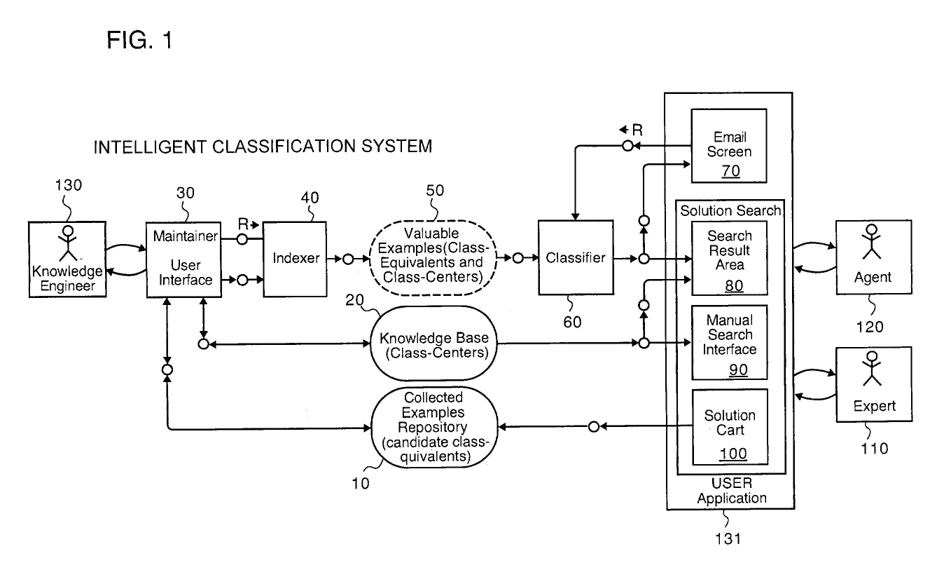

As shown in FIG. 1, a computer-based system provides for intelligent classification services. The system is designed to provide automatic recommendations based upon a classification of an incoming message. For example, in one implementation, the system may provide recommended solutions to a given problem description contained in the incoming message. In another implementation, the system may provide a suggestive list of persons or entities given a request for information contained in the incoming message.

As shown in FIG. 1, the system includes a knowledge base that serves as a repository of information. Although only a single knowledge base 10 is illustrated in FIG. 1, the system may be configured to support multiple knowledge bases. The knowledge base 10 may include a collection of documents such as electronic mail (e-mail message), web pages, business documents, faxes, etc. that may be searched by users. In one implementation, the knowledge base 10 stores authoritative problem descriptions and corresponding solutions. Each problem description and corresponding solution stored in knowledge base 10 represents a particular class of problems and may be derived from a previous request for information. Because of this, each problem description and its corresponding solution stored in knowledge base 10 may be referenced to as a class-center.

A repository for collected examples 20 is provided that stores non-authoritative semantically equivalent problem descriptions and pointers to corresponding solutions stored in knowledge base 10. Each non-authoritative semantically equivalent problem description and pointer may be referenced to as a class-equivalent and may be derived from a previous request for information. In one implementation, the determination of class-equivalents may be determined by an expert 110 or by an agent 120. For example, in a call center context, the expert 110 may be an individual familiar with the subject topic of an unclassified problem description. Although only a single expert and agent are illustrated in FIG. 1, the system may be configured to support multiple experts and agents.

A maintainer user interface 30 may be provided that allows a user to edit problem descriptions stored in both the repository of collected examples 20 and knowledge base 10. The user of the interface 30 may be, for example, a knowledge engineer 130 responsible for post-processing and maintenance of class-equivalents stored in the collected examples repository 20 and class-centers stored in knowledge base 10. In one implementation, the knowledge engineer 130 may be responsible for creating additional class-equivalents and editing unclassified problem descriptions to better serve as class-equivalents. In other implementations, maintenance of the collected examples repository 20 and knowledge base 10 may be performed automatically.

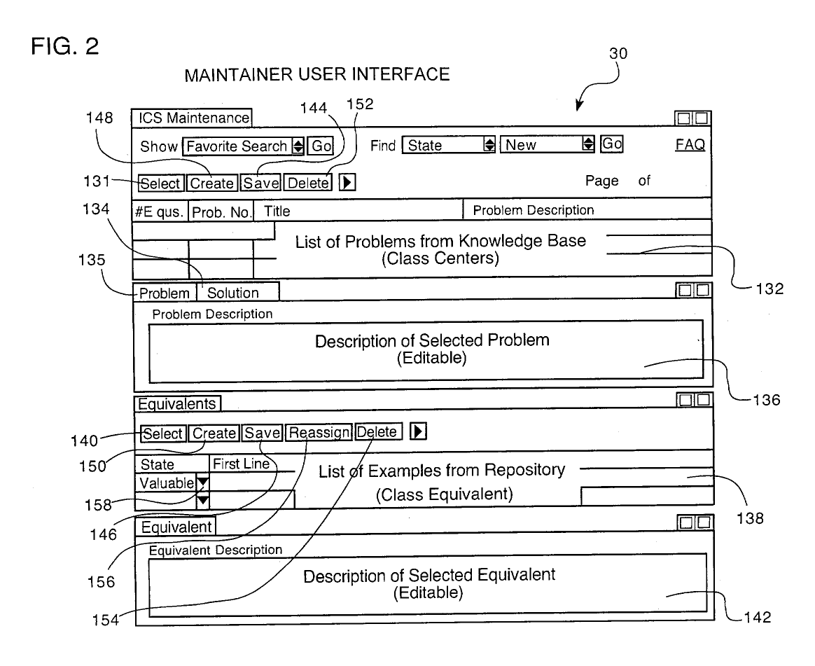

Referring to FIG. 2, the maintainer user interface 30 is illustrated. In one implementation, a list of class-centers 132 stored in knowledge base 10 may be displayed. The knowledge engineer 130 may select a class-center from the list of class-centers 132. Once the knowledge engineer presses a first select button 131, the maintainer user interface 30 may display the problem description relating to the selected class-center in an editable problem description area 136 and any class-equivalents associated with the selected class-center in a list of class-equivalents 138. The knowledge engineer 130 may toggle between the class-center problem description and class-center problem solution by selecting problem description button 135 and problem solution button 134. The knowledge engineer 130 may select a class-equivalent from the list of class-equivalents 138 and press a second select button 140. Once second select button 140 is selected, the maintainer user interface 30 may display the equivalent problem description relating to the selected class-equivalent in an editable equivalent description area 142.

The maintainer user interface 30 provides save functions 144, 146 that store edited problem descriptions in knowledge base 10 and equivalent problem descriptions in the collected examples repository 20. The maintainer user interface may provide create functions 148, 150 that generate class-centers in knowledge base 10 and class-equivalents in the collected examples repository 20. Furthermore, the maintainer user interface 30 may provide delete functions 152, 154 to remove class-centers from knowledge base 10 and class-equivalents from the collected examples repository 20 and a reassign function 156 that may associate an already associated class-equivalent to another class-center.

The maintainer user interface 30 also may provide state information regarding class-equivalents stored in the collected examples repository 20. The state of a class-equivalent may be, for example, “valuable” or “irrelevant.” The knowledge engineer may decide which of the collected examples are “valuable” by accessing a state pull-down menu 158 associated with each class-equivalent and selecting either the “valuable” or “irrelevant” option.

Referring to FIG. 1, an indexer 40 is provided that transforms “valuable” class-equivalents stored in collected examples repository 20 and class-centers stored in knowledge base 10 into valuable examples 50, which may also be referred to as a text-mining index, which may be used as input by a classifier 60 to provide automatic solution recommendations. In one implementation, the indexer 40 may be invoked from the maintainer user interface 30. Other implementations may invoke the indexer 40 depending on the number of new or modified class-equivalents stored in the collected examples repository 20 or class-centers stored in the knowledge base 10.

A user application 131 provides access to problem descriptions and solutions in knowledge base 10 and collects class-equivalents for storage in the repository for collected examples 20. In one implementation, the system may be used by agent 120 and expert 110 to respond to incoming customer messages. In other implementations, user application 131 may be provided directly to customers for suggested solutions.

The user application 131 provides an e-mail screen 70 and a solution search display 105 comprising a manual search interface 90, a solution cart component 100, and search result area 80 which displays auto-suggested solutions as well as solutions from manual search interface 90. The user application 131 may be utilized by both an expert 110 and an agent 120 to respond to problem descriptions. Although only a single expert and agent are illustrated in FIG. 1, the system may be configured to support multiple experts and agents. In one implementation, the expert 110 may be an individual possessing domain knowledge relating to unclassified problem descriptions. The agent 120 may be a customer interacting directly with the system or a person interacting with the system on behalf of a customer. Other implementations may blend and vary the roles of experts and agents.

In an illustrative example, a customer may send a request for information including a problem description to the system via an electronic message. An e-mail screen 70 may be implemented where the agent 120 may preview the incoming electronic message and accept it for processing. Once an incoming message has been accepted, the classifier 60 of the intelligent classification system may be invoked automatically and suggest one or more solutions from knowledge base 10 using text-mining index 50. In one implementation, the system may automatically respond to the incoming message based upon a level of classification accuracy calculated by the classifier 60. In other implementations, agent 120 and expert 110 may respond to the incoming message based upon one or more solutions recommended by classifier 60.

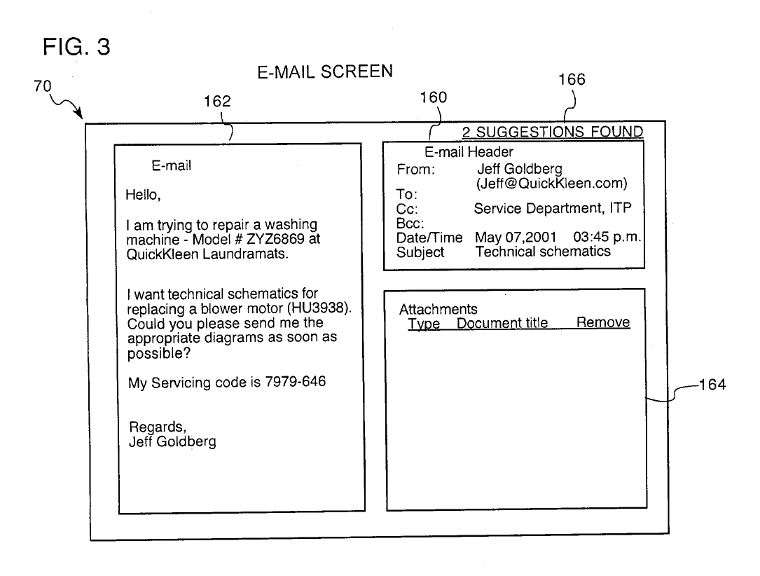

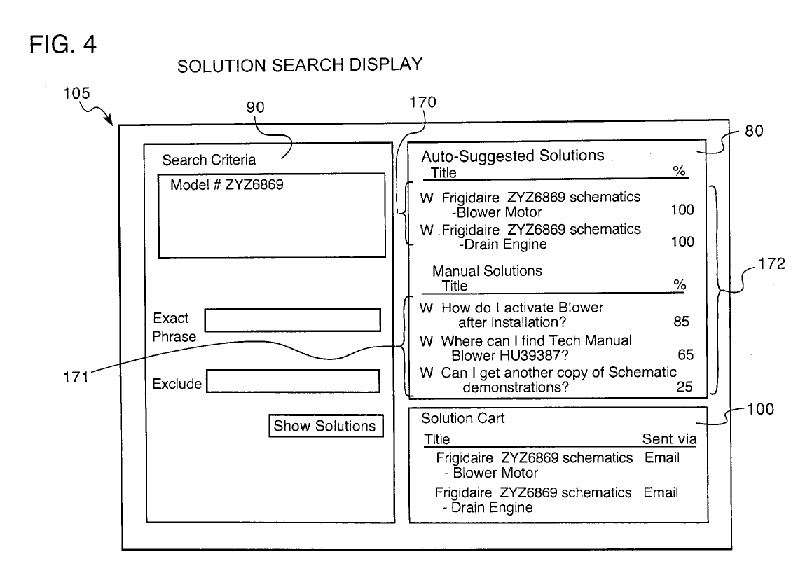

FIG. 3 illustrates an implementation of an email screen 70 that may be accessed by agent 120. The display may include areas for an electronic message header 160 including information about the source, time and subject matter of the electronic message. An electronic message text area 162 may be used to display the problem description contained in the electronic message. Upon acceptance of the electronic message, the classifier 60 may process the electronic message and generate one or more recommended solutions. In one implementation, the number of recommended solutions by the classifier may be displayed as an electronic link 166. Selecting electronic link 166 triggers navigation to the solution search display 105 shown in FIG. 4 described below. After having selected suitable solutions on the solution search display 105, the selected solutions appear on the email screen 70 in an attachments area 164. The objects in the attachments area 164 of display 70 are sent out as attachments to the email response to the customer.

FIG. 4 illustrates an example of the solution search display 105 that also may be used by agent 120 and expert 110 to respond to electronic messages. In one implementation, recommended solutions 170 by classifier 60 may be displayed in search result area 80.

For situations where recommended solutions do not match the problem description sufficiently, a manual search interface 90 of solution search display 105 is provided. The manual search interface 90 may be used to compose and execute queries that retrieve manual solutions 171 (i.e., class-centers) from knowledge base 10.

A class-score 172 indicating the text-mining similarity of the recommended solution to the electronic message also may be provided. In addition, the solution display 105 also may provide drilldown capabilities whereby selecting a recommended solution in the search result area 80 displays detailed problem descriptions and solutions from knowledge base 10 identified by classifier 60.

A solution cart component 100 of solution search display 105 provides a method for collecting and storing new candidates of class-equivalents in collected examples repository 20 and responding to customers with selected solutions. One or more recommendations identified in search result area 80 may be selected for inclusion in the solution cart component 100. In one implementation, storing class-equivalents may be done in explicit form by posing questions to expert 110. In other implementations, storing class-equivalents may be done in an implicit form by observing selected actions by expert 110. Selected actions may include responding to customers by e-mail, facsimile (fax), or web-chat. Either method of feedback, implicit, explicit, or both may be supported by the system.

Referring to FIG. 1, the classifier 60 provides case-based reasoning. The classifier 60 may use the k-nearest-neighbor technique to match a problem description contained in an electronic message with the valuable examples stored in form of a text-mining index 50. The classifier 60 may use a text-mining engine to transform the problem description into a vector, which may be compared to all other vectors stored in text-mining index 50. The components of the vector may correspond to concepts or terms that appear in the problem description of the electronic message and may be referred to as features.

The classifier 60 may calculate the distance between the vector representing the customer problem and each vector stored in text-mining index 50. The distance between the vector representing the customer problem description and vectors stored in text-mining index 50 may be indicative of the similarity or lack of similarity between problems. The k vectors stored in text-mining index 50 (i.e. class-centers and class-equivalents) with the highest similarity value may be considered the k-nearest-neighbors and may be used to calculate an overall classification accuracy as well as a scored list of potential classes matching a particular problem description.

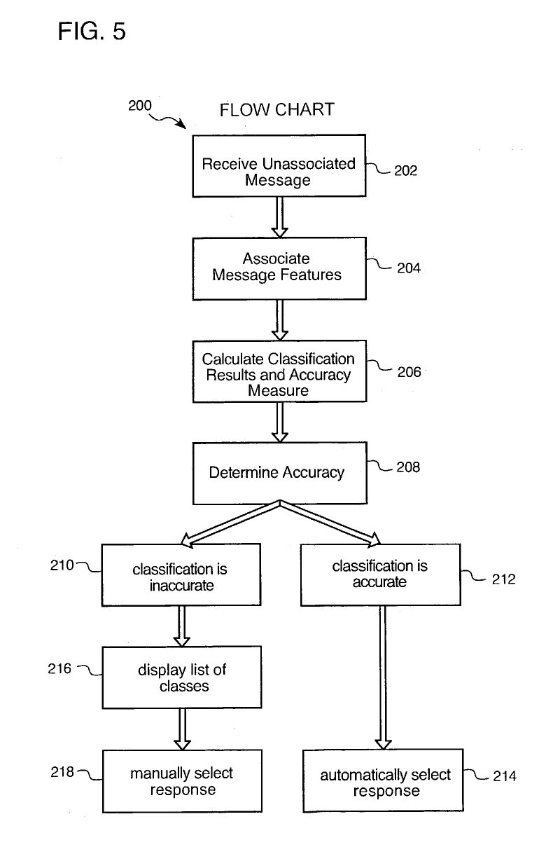

Referring to FIG. 5, a flow chart 200 of an implementation of the classifier 60 is illustrated. An electronic message is received 202 that is not associated with a class where a class is an association of documents that share one or more features. The message may include one or more problem descriptions.

The classifier 60 transforms the message into a vector of features 204 and may calculate a classification result 206 that includes a list of candidate classes with a class-weight and a class-score for each candidate class, as well as an accuracy measure for the classification given by this weighted list of candidate classes.

For each neighbor dᵢ (where i=1, . . . ,k), the text-mining search engine may yield the class cᵢ to which the neighbor is assigned to and a text-mining score sᵢ that may measure the similarity between the neighbor and the unassociated message. Within the k-nearest-neighbors of the unassociated message, only κ<k distinct candidate classes γⱼ (where j=1, . . . ,κ) are present.

Based on the above information of the k-nearest-neighbors, the classifier 60 may calculate the classification result. In one implementation, the classification result may include a class-weight and a class-score.

The class-weight wⱼ may measure the probability that a candidate class γⱼ identified in text-mining index 50 is the correct class for classification. In one implementation, class-weights may be calculated using the following formula:

Class-weights proportional to text-mining scores for j in the set of 1, . . . ,κ:

$${w}_{j} = {\sum }_{{c}_{i} = {c}_{j}} {s}_{i} / \sum {s}_{i} ( summed over i = 1 , … , k )$$

In other implementations, class-weights also may be calculated using text-mining ranks from the text-mining search assuming the nearest-neighbors dᵢ are sorted descending in text-mining score. Class-weights using text-mining ranks may be calculated using the following formula:

Class-weights proportional to text-mining ranks for j in the set of 1, . . . ,κ:

$$\begin{matrix}{w}_{j} = {\sum }_{{c}_{i} = {c}_{j}} ( k + 1 - i ) / \sum ( k + 1 - i ) = 2 {\sum }_{{c}_{i} = {c}_{j}} \frac{k + 1 - i}{k ( k + 1 )} \\ ( summed over i = 1 , … , k )\end{matrix}$$

The classifier 60 also may calculate an accuracy measure a that may be normalized (i.e. 0≦σ≦1) and that signifies the reliability of the classification.

Class-weights also may relay information regarding how candidate classes γⱼ are distributed across the nearest-neighbors and may be used as a basis to calculate an accuracy measure. For example, normalized entropy may be used in combination with definitions of class-weights using the following formula for classification accuracy:

$${σ}^{( n )} = 1 - S / {S}_{max} = 1 + {\sum }_{j = 1}^{κ} {w}_{j} {log}_{n} {w}_{j} ,$$

where n=k for a global accuracy measure; and n=κ for local accuracy measure.

The global accuracy measure may take into account all classes, while the local accuracy measure may only account for classes present in the k-nearest-neighbors.

The classifier 60 may also calculate class-scores which may be displayed to agent 120 and expert 110 to further facilitate understanding regarding candidate classes and their relatedness to the unassociated message. In contrast to the normalized class-weights, class-scores need not sum to one if summed over all candidate classes.

For example, if the focus of the user is on classification reliability, classifier 60 may set the class-score equal to class-weights. Alternatively, if the focus of the user is on text-mining similarity between candidate classes and the unassociated message, the classifier 60 may allow the class-score to deviate from the class-weights. In one implementation, the class-score tⱼ may be calculated as an arithmetic average of the text-mining scores per class using the following formula (for each j in the set of 1, . . . ,κ):

$${t}_{j} = {\sum }_{{c}_{i} = {c}_{j}} {s}_{i} / {\sum }_{{c}_{i} = {c}_{j}} 1 ( summed over i = 1 , … , k )$$

In another implementation, class-score may be calculated as the weighted average of the text-mining scores per class using the following formula (for each j in the set of 1, . . . ,κ):

$${t}_{j} = {\sum }_{{c}_{i} = {c}_{j}} {( {s}_{i} )}^{2} / {\sum }_{{c}_{i} = {c}_{j}} {s}_{i} ( summed over i = 1 , … , k )$$

In other implementations, class-score may be calculated as a maximum of text-mining scores per class using the following formula (for each j in the set of 1, . . . ,κ):

$${t}_{j} = {max}_{{c}_{i} = {c}_{j}} ( {s}_{i} ) ( evaluated over i = 1 , … , k )$$

The class-score calculated by the arithmetic average may underestimate the similarity between the class and the unassociated message if the variance of the text-mining scores in the class is large. In contrast, the class-score calculated as a maximum text-mining score per class may overestimate the similarity. The class-score calculated as the weighted average may be a value between these extremes. Although three class-score calculations have been disclosed, classifier 60 may support additional or different class-score calculations.

Referring to FIG. 5, the classifier 60 may determine if the classification is accurate 212 based upon the calculated accuracy measure. In one implementation, the classifier 60 automatically selects 214 a response to the incoming message incorporating a solution description. If the classification is inaccurate 210, based upon the accuracy measure value, the classifier 60 may display 216 class-centers and class-equivalents and allow the agent 120 and expert 110 to manually select 218 a response including a solution description from the classes displayed.

The intelligent classification system provides generic classification services. In one implementation, for example, the system may serve as a routing system or expert finder without modification. The system may classify problem descriptions according to the types of problems agents have solved so that customer messages may be automatically routed to the most competent agent. The recommendation also may be a list of identifiers, each of which corresponds to a respective group of one or more suggested persons or entities knowledgeable about subject matter in the problem description.

The system, however, is not limited to incoming problem descriptions. In one implementation, the system may be used in a sales scenario. For example, the system may classify an incoming customer message containing product criteria with product descriptions in a product catalog or with other examples of customer descriptions of products to facilitate a sale.

Various features of the system may be implemented in hardware, software, or a combination of hardware and software. For example, some features of the system may be implemented in computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

Other implementations are within the scope of the claims.

What is claimed is:

1. A method comprising:
receiving a message including a request for information;
classifying the request for information based upon features of the message; and
providing a recommendation based upon the classification.

2. The method of claim 1 wherein the request for information comprises a problem description and the recommendation comprises a recommended solution.

3. The method of claim 1 wherein the recommendation comprises a list of suggested entities based on the request for information.

4. The method of claim 3 wherein the recommendation further comprises one or more identifiers, each of which corresponds to a respective group of one or more individuals knowledgeable about subject matter of the request for information and the method further comprising routing the message to the one or more individuals.

5. The method of claim 1 wherein classifying the request for information comprises:
comparing the request for information with previous requests for information; and
determining which previous requests are most similar to the request for information.

6. The method of claim 5 wherein determining which previous requests are most similar to the request for information comprises using a k-nearest-neighbor algorithm.

7. The method of claim 1 wherein providing a recommendation comprises:
generating a classification result using a scored list of candidate classes as input;
calculating an accuracy measure using class-weights associated with candidate classes as input; and
comparing the accuracy measure to a predetermined value.

8. The method of claim 7 further comprising displaying a class-score indicating a text-mining similarity with the request for information.

9. The method of claim 7 further comprising displaying messages from the candidate classes.

10. The method of claim 7 further comprising sending a recommendation based on the accuracy measure and the predetermined value comparison.

11. The method of claim 1 comprising updating a repository of collected examples that stores requests for information in response to a user providing a recommendation in response to the request for information.

12. The method of claim 1 comprising associating a tag value to a class equivalent as indicia of relevance to a class-center.

13. An article comprising a machine-readable medium storing machine-executable instructions that, when executed, cause a machine to perform operations comprising:
classify a request for information included in a received message based upon features of the message; and
provide a recommendation based upon the classification of the message.

14. The article of claim 13 including instructions, that when applied to the machine, cause the machine to provide a recommended solution in response to a problem description in the received message based on the classification.

15. The article of claim 13 including instructions, that when applied to the machine, cause the machine to provide a list of suggested entities in response to the request for information based on the classification.

16. The article of claim 13 wherein the recommendation comprises one or more identifiers, each of which corresponds to a respective group of one or more individuals knowledgeable about subject matter of the request for information including instructions, that when applied to the machine, cause the machine to route the message to the one or more individuals.

17. The article of claim 13 including instructions, that when applied to the machine, cause the machine to:
compare the request for information with previous requests for information; and
determine which previous requests are most similar to the request for information.

18. The article of claim 17 including instructions, that when applied to the machine, cause the machine to use a k-nearest-neighbor algorithm to determine which previous requests are most similar to the request for information.

19. The article of claim 13 including instructions, that when applied to the machine, cause the machine to:
generate a classification result using as input a scored list of candidate classes;
calculate an accuracy measure using class-weights associated with candidate classes as input; and
compare the accuracy measure to a predetermined value.

20. The article of claim 17 including instructions, that when applied to the machine, further cause the machine to display a class-score indicating a text mining similarity with the request for information.

21. The article of claim 17 including instructions, that when applied to the machine, further cause the machine to display messages from the candidate classes.

22. The article of claim 17 including instructions, that when applied to the machine, further cause the machine to send a recommendation based on the accuracy measure and the predetermined value comparison.

23. The article of claim 13 including instructions, that when applied to the machine, cause the machine to update a repository of collected examples that stores requests for information in response to a user providing a recommendation in response to the request for information.

24. The article of claim 13 including instructions, that when applied to the machine, cause the machine to associate a tag value to a class equivalent as an indicia of relevance to a class-center.

25. A system comprising:
a computer network;
a directory coupled to the network, the directory storing a knowledge base and a repository for collected examples;
a user interface coupled to the network to allow a user independently to request and receive recommendations; and
a service delivery device coupled to the network,
wherein the service delivery device includes a processor and memory storing instructions that, in response to receiving a request for information, cause the processor to:
classify the request based upon features of the message; and
provide a recommendation based upon the classification.

26. The system of claim 25 wherein the memory stores instructions that, in response to receiving the request, causes the processor to provide a recommended solution in response to a problem description in the received message based on the classification.

27. The system of claim 25 wherein the memory stores instructions that, in response to receiving the request, cause the processor to provide a list of suggested entities in response to the request for information based on the classification.

28. The system of claim 27 wherein the recommendation comprises one or more identifiers, each of which corresponds to a respective group of one or more individuals knowledgeable about subject matter of the request for information including instructions, that when applied to the machine, cause the machine to route the message to the one or more individuals.

29. The system of claim 25 wherein the memory stores instructions that, in response to receiving the request, cause the processor to:
compare the request for information with previous requests for information; and
determine which previous requests are most similar to the request for information.

30. The system of claim 29 wherein the memory stores instructions that, in response to receiving the request, cause the processor to use a k-nearest-neighbor algorithm to determine which previous requests are most similar to the request for information.

31. The system of claim 25 wherein the memory stores instructions that, in response to receiving the request, cause the processor to:
generate a classification result using a scored list of candidate classes as input;
calculate an accuracy measure using class-weights associated with candidate classes as input; and
compare the accuracy measure to a predetermined value.

32. The system of claim 31 wherein the memory stores instructions that, in response to receiving the request, further cause the processor to display a class-score indicating a text mining similarity with the request for information.

33. The system of claim 31 wherein the memory stores instructions that, in response to receiving the request, further cause the processor to display messages from the candidate classes.

34. The system of claim 31 wherein the memory stores instructions that, in response to receiving the request, further cause the processor to send a recommendation based on the accuracy measure and the predetermined value comparison.

35. The system of claim 25 wherein the memory stores instructions that, in response to receiving the request, further cause the processor to update a repository of collected examples that stores requests for information in response to a user providing a recommendation in response to the request for information.

36. The system of claim 25 wherein the memory stores instructions that, in response to receiving the request, cause the processor to associate a tag value to a class equivalent as an indicia of relevance to a class-center.
